(19) United States
(12) Patent Application Publication
(10) Pub. No.: US 2011/0044134 A1
(43) Pub. Date: Feb. 24, 2011

(54) Clock for Motorcycle

(76) Inventor: David James Harris, Lichfield (GB)

Correspondence Address: David James Harris, 1 Station Road, Shenstone, Lichfield, WS14 0NW, GB

(21) Appl. No.: 12/859,783

(22) Filed: Aug. 20, 2010

Related U.S. Application Data
(60) Provisional application No. 61/236,102, filed on Aug. 23, 2009.

(51) Int. Cl. G04B 47/00

(52) U.S. Cl. 368/10

(57) ABSTRACT

A clock (10) for a motorcycle, comprising a plurality of display elements (11) switchable between first and second states, where the first state is visibly different to the second state, and a light transmissive carrier (50) for the display elements (11), the display elements being arranged on the carrier (50) so as to define a clock, the carrier being sized and shaped so as to be fixable to an instrument (4) of the motorcycle such as a tachometer or speedometer, such that the instrument (4) can be viewed through the carrier (50) and the display elements (11) in at least one state of the display elements (11).

### CROSS-REFERENCE TO RELATED APPLICATIONS

This application claims the benefit of U.S. Provisional Patent Application No. 61/236,102, filed 23 Aug. 2009.

### STATEMENT REGARDING FEDERALLY SPONSORED RESEARCH OR DEVELOPMENT.

Not applicable

### THE NAMES OF THE PARTIES TO A JOINT RESEARCH AGREEMENT

Not applicable

### INCORPORATION-BY-REFERENCE OF MATERIAL SUBMITTED ON A COMPACT DISC

Not applicable

### BACKGROUND OF THE INVENTION

1. Field of the Invention

This invention relates to a clock for a motorcycle.

2. Description of Related Art

Motorcycles are a popular form of transport, which offer a freedom of movement not generally found in cars in today's urban traffic levels. However, the instrumentation found on a motorcycle instrument cluster tends to be somewhat limited compared to that generally found on a car; this is due to a lack of space. In particular, it is common for motorcycles to lack a clock. Obviously, it is useful to be able to tell the time whilst riding.

### BRIEF SUMMARY OF THE INVENTION

According to a first aspect of the invention, there is provided a clock for a motorcycle, comprising a plurality of display elements switchable between first and second states, where the first state is visibly different to the second state, and a light transmissive carrier for the display elements, the display elements being arranged on the carrier so as to define a clock, the carrier being sized and shaped so as to be fixable to an instrument of the motorcycle such that the instrument can be viewed through the carrier and the display elements in at least one state of the display elements.

This allows a clock to be displayed over the instrument, with the display elements forming the clock but preferably allowing the instrument to viewed through the display elements; in the preferred embodiment the instrument would be viewable through the display elements regardless of their state.

Preferably, by sized and shaped, we mean that the carrier and the display elements can be fixed within a 5 cm, 7.5 cm or 10 cm circle. Such a clock can conveniently be fitted to the tachometer of a motorcycle; some obscuration of the tachometer can be seen to be acceptable as the information conveyed by the tachometer is useful but not essential. The carrier or the display elements may be planar.

Given that the instrument may still be seen through the clock, the instrument may be a speedometer of the motorcycle, although that is less preferred.

Typically, in the first and second states the display elements have differing light transmission levels; alternatively, the in the first and second states the display elements may emit different levels of light.

By “can be viewed”, we may mean that the light transmission characteristics of the display elements in the relevant states is such that at least the outline of the elements of the instrument can be made out. Viewable may comprise at least 10%, 25% or 50% light transmission in the relevant state.

For visibility's sake, the display elements may in the second state scatter more light in a diffuse fashion than in the first state. This aids visibility, as diffuse scattering can lead to improved contrast between the first and second states.

The display elements may comprise liquid crystal (LC) elements. The LC elements may comprise LC material positioned between two light-transmissive electrodes. At least one of the electrodes may be segmented so as to define the shape of the display elements. The other electrode may be provided in common for all the display elements, and may cover the entire area of the carrier covered by the display elements. The electrodes may comprise indium tin oxide (ITO) or other suitable clear conductive materials.

The display elements may comprise light emitting elements that emit light, in use, in one of the first or second states (preferably the second). This is useful when riding in the dark, although it is possible that the backlighting of the instrument would be sufficient. The light emitting elements may comprise an electroluminescent phosphor, which may be sandwiched between a pair of drive electrodes.

The clock may further comprise drive circuitry for the display elements. It may also comprise a power supply for the display elements and/or the drive circuitry. At least one of the drive circuitry and the power supply may be housed within a housing that can fitted to a side of the instrument. The power supply may comprise at least one of a battery and a solar power cell.

According to a second aspect of the invention, there provided a display instrument for a motorcycle, comprising an indicator for a characteristic of the motorcycle and a clock according to the first aspect of the invention, in which the indicator is visible through the clock.

### BRIEF DESCRIPTION OF THE SEVERAL VIEWS OF THE DRAWING(S)

There now follows, by way of example only, an embodiment of the present invention, described with reference to the accompanying drawings, in which:

FIG. 1 shows a schematic diagram of a motorcycle instrument panel according to an embodiment of the invention;

FIG. 2 shows an alternative clock graphic for use in the present invention; and

FIG. 3 shows a cross section through the overlay of the clock of FIG. 1 or 2.

### DETAILED DESCRIPTION OF THE INVENTION

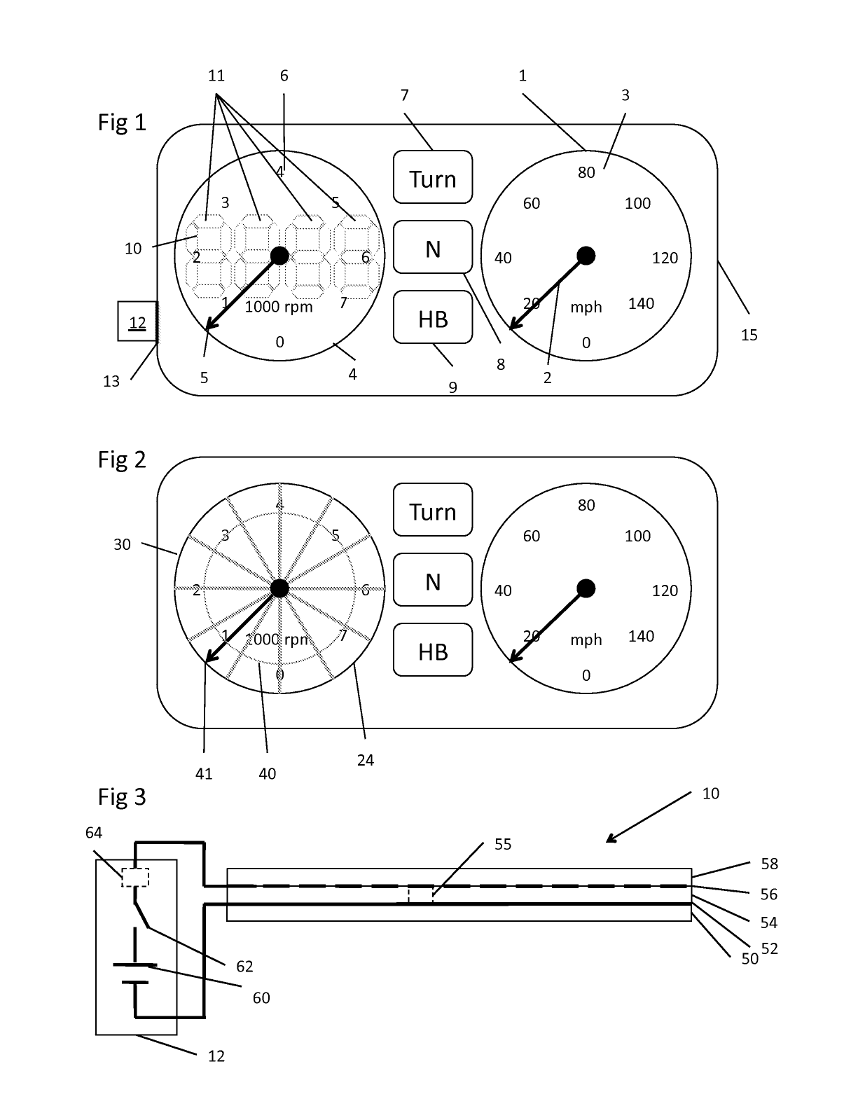

FIG. 1 of the accompanying drawings shows a motorcycle instrument panel 15 according to a first embodiment of the invention. As is common in the prior art, this comprises a speedometer 1, which indicates the speed of the motorcycle by means of a needle 2 pointing at a scale 3. Whilst the scale is depicted in miles per hour (mph) any other suitable scale, such as kilometres per hour (kph) could be used.

Again as is common, the instrument panel comprises a tachometer 4, which indicates the rotational speed of the motorcycle's engine. This again comprises a needle 5, which points to a scale 6. The scale shown is in revolutions per minute (rpm), but again any suitable scale could be used.

The instrument panel can also comprise informational lights, such as the indicator activation lights 7, which show when the motorcycle's directional indicators are illuminated, a neutral light 8, which shows when the neutral gear has been selected, and a high beam light 9, which shows when a high, rather than dipped, beam headlight has been selected.

In the panel of this embodiment of the invention, the tachometer 4 is provided with an overlay 10, which depicts the time using a digital display. The overlay is a four digit segmented display, where each of the four digits 11 comprises seven segments that can be activated separately. Seven-segment displays are common, and each digit 11 can be used to display any of the digits from zero to nine as is familiar from digital clocks and watches.

However, I have appreciated a novel use for such digital displays. The overlay 10 is positioned over the tachometer 4, and each of the segments of the digits 11 can be activated independently in two visibly different states, as will be discussed below.

In either or both of the two states, the tachometer 4 is still visible through the overlay 10. Accordingly, a digital display of the time can be overlaid over the tachometer.

The display is controlled by a control unit 12, which is attached by means of a self-adhesive pad 13 to a side of the panel 15. This control unit comprises a battery (not shown) to provide power to the overlay 10. It also comprises a clock circuit (not shown), which keeps track of the time; such circuits are well known in the prior art. Finally, it comprises a drive circuit by means of which the segments can be selectively illuminated; generally, this will comprise a circuit by means of which a voltage can be applied between pairs of electrodes, each pair defining one of the segments; typically, an common “earth” electrode will be provided, with a segment electrode being provided for each segment. By applying an appropriate voltage to each segment electrode relative to the common electrode, the appropriate segment may be activated.

In a second embodiment of the invention shown in FIG. 2 of the accompanying drawings, rather than the classic digital display shown in FIG. 1, a simulation of an analogue clock is provided. Equivalent integers to those of the embodiment of FIG. 1 have been given the same reference numeral, raised by 20.

In this embodiment, the overlay 30 is of the form of a circular disc 40, divided into 12 sectors. This is concentrically surrounded by an annular ring 41, which is divided into 12 sectors circumferentially co-extensive with the sectors of the disc 40. The sectors of the disc and of the ring together form the segments of the overlay 30. The sectors can be individually actuated.

As such, the sectors of the disc 40 imitate the hour hand of a twelve-hour two-hand analogue clock, and so indicate the hour, in the manner of the small hand of an analogue clock. The sectors of the ring 41 indicate the minute of the time, to a five-minute accuracy, in the manner of the large hand of an analogue clock.

The functioning of the overlays of either of the above two embodiments will now be explained with reference to FIG. 3 of the accompanying drawings, although the numbering of FIG. 1 is used. The overlay 10 comprises a flexible clear plastic substrate 50. On top of this is provided a clear electrode 52, which acts as an electrode for all of the segments in common. It is formed of a material such as indium tin oxide (ITO).

Over the electrode is provided the active material 54, which causes the segment to change appearance. One example for the active material would be a liquid crystal material, which either changes the polarisation of light passing therethrough dependent on an electric field applied to the material (in which case additional polarisers will be added above and below the active material 54), or acts to scatter light dependent upon such an electric field. Another option for the active material 54 would be a thin layer of electroluminescent phosphor, which emits light on application of an appropriate electric field.

Above the active material 54, there is provided a patterned electrode 56. This is another transparent conductive electrode made of a material such as Indium Tin Oxide (ITO). The pattern of the electrode defines the segments 11 of the overlay 10, such that for each segment 11 there is provided a segment of the patterned electrode that is separately energisable. The section of active material (such as that highlighted at 55) sandwiched between the relevant section of the patterned electrode and the common electrode 52 will activate on energisation of the relevant section of the patterned electrode.

The control unit 12 is also shown in more detail in FIG. 3; only the detail used for driving the overlay 10 is shown. This comprises a battery 60 and a switch 62 in series. The switch is controlled by parts of the control unit 12 not shown that keep the time and decide which segments should be activated; a switch is provided for each segment 11. A voltage conversion circuit 64 may be provided if it is required to convert the battery 60 voltage to another voltage for the active material; for example, most batteries provide direct current at around 1.5 volts, whereas electroluminescent phosphors require approximately 200 volts alternating current (but at relatively low current). The negative terminal of the battery 60 and the output of the switch 62 (or the voltage conversion circuit 64 if that is provided) are connected to the common electrode 52 and the patterned electrode 56 respectively.

As such, the clock of either of these embodiments can be provided simply on a motorcycle instrument. It can be retrofitted to any motorcycle with a suitable instrument; given that most motorcycles have a circular instrument of at least 7.5 cm in diameter, most motorcycles will be suitable. Both the overlay 10 and the control unit 12 can be fitted using self-adhesives to the appropriate members, easily.

1. A clock for a motorcycle, comprising a plurality of display elements switchable between first and second states, where the first state is visibly different to the second state, and a light transmissive carrier for the display elements, the display elements being arranged on the carrier so as to define a clock, the carrier being sized and shaped so as to be fixable to an instrument of the motorcycle such that the instrument can be viewed through the carrier and the display elements in at least one state of the display elements;
in which the clock further comprises a housing that can be fitted to a side of the instrument, the housing containing at least one of the following: drive circuitry for the display elements; and a power supply for the display.

2. The clock of claim 1, in which the instrument is a tachometer or speedometer of a motorcycle.

3. The clock of claim 1, in which in the first and second states the display elements have differing light transmission levels.

4. The clock of claim 1, in which in the first and second states the display elements emit different levels of light.

5. The clock of claim 1, in which the display elements in the second state scatter more light in a diffuse fashion than in the first state.

6. A display instrument for a motorcycle, comprising an indicator for a characteristic of the motorcycle and a clock, the clock comprising a plurality of display elements switchable between first and second states, where the first state is visibly different to the second state, and a light transmissive carrier for the display elements, the display elements being arranged on the carrier so as to define a clock, the carrier being sized and shaped so as to be fixable to an instrument of the motorcycle such that the instrument can be viewed through the carrier and the display elements in at least one state of the display elements;
in which the clock further comprises a housing attached to a side of the instrument, the housing containing at least one of the following: drive circuitry for the display elements; and a power supply for the display.

7. The display instrument of claim 6, in which the indicator is selected from the group comprising a speedometer and a tachometer.

8. A method of retrofitting a clock to an instrument of a motorcycle, the clock comprising a plurality of display elements switchable between first and second states, where the first state is visibly different to the second state, and a light transmissive carrier for the display elements, the display elements being arranged on the carrier so as to define a clock, the method comprising fixing the carrier to the instrument such that the instrument can be viewed through the carrier and the display elements in at least one state of the display elements.

9. The method of claim 8, in which the clock further comprises a housing that can be fitted to a side of the instrument, the housing containing at least one of the following: drive circuitry for the display elements; and a power supply for the display, and the method further comprises the step of fixing the housing to a side of the instrument.
